(19) United States
(12) Patent Application Publication
(10) Pub. No.: US 2008/0313455 A1
(43) Pub. Date: Dec. 18, 2008

(54) KEY SUPPORT FOR PASSWORD-BASED AUTHENTICATION MECHANISMS

(75) Inventor: Dirk KROESELBERG, Munchen (DE)

Correspondence Address: BRAKE HUGHES BELLERMANN LLP, c/o INTELLEVATE, P.O. BOX 52050, MINNEAPOLIS, MN, 55402, US

(73) Assignee: Nokia Siemens Networks Oy, Espoo (FI)

(21) Appl. No.: 11/762,034

(22) Filed: Jun. 12, 2007

(51) Int. Cl. H04L 9/32

(52) U.S. Cl. 713/153; 713/168

(57) ABSTRACT

According to an example embodiment, a session key (e.g., MSK/EMSK) may be determined for a password-based authentication method based on a secret and one or more security parameters used for peer authentication of the method. For example, a session key (e.g., EMSK) may be determined for a EAP-MSCHAP (Extensible Authentication Protocol-Microsoft PPP CHAP Extension) protocol family method between a peer node and an EAP server, the determining being based on a secret and one or more security parameters used for the EAP-MSCHAP protocol family peer authentication.

### BACKGROUND

Extension Authentication Protocol (EAP) is an example of an authentication framework that is used by wired and wireless networks (see “Extensible Authentication Protocol,” RFC 3748, June 2004). EAP provides some common functions and a negotiation of a desired authentication mechanism (referred to as an EAP method). EAP supports multiple authentication mechanisms (EAP methods).

Tunneled authentication is sometimes used with EAP. There are a number of different EAP tunneling mechanisms that have been proposed, such as “EAP Tunneled TLS Authentication Protocol Version 0”, Internet Draft, 2005 (EAP-TTLSv0). Other EAP tunneling mechanisms may include EAP-FAST, PEAP (protected EAP), for example. These may involve the use an EAP method that runs through (or within) an outer tunnel or TLS-based tunnel. TLS (Transport Layer Security), and its predecessor (SSL or Secure Sockets Layer), are cryptographic protocols which may provide secure communications.

Password-based authentication and authorization mechanisms may also be provided, which may allow use of user ID and passwords. An example may be Microsoft PPP CHAP Extensions, Version 2, rfc2759, January 2000 (MSCHAPv2). MSCHAPv2 may be used as an EAP method. Unfortunately, when MSCHAPv2 is used as an EAP method (EAP-MSCHAPv2), it does not provide session keys MSK (Master Session Key) and EMSK (Extended Master Session Key), as required by RFC 3748. The MSK key may be used for example, for authentication or protection for a wireless link, while the EMSK is sometimes used for protection of application data.

Furthermore, when EAP-MSCHAPv2 is used as an inner EAP method in a tunneled method (like EAP-TTLSv0), the outer TLS-based tunnel may provide for derivation of the MSK and EMSK keys. However, where different EAP servers are used to terminate the outer TLS-based tunnel and the inner EAP-MSCHVAPv2 method, the session keys (MSK, EMSK) required by RFC 3748 are typically available (or derived) only at the peer and at the EAP server terminating the TLS-based tunnel, and are typically not available at the EAP server terminating the inner EAP-MSCHAPv2 method.

### SUMMARY

Various example embodiments are disclosed relating to providing key support for password-based authentication methods.

One example embodiment may include determining, at a home authentication server in a wireless network, a session key for a tunneled password-based authentication method based on a secret and one or more security parameters used for peer authentication of the authentication method between the home authentication server and the wireless peer node.

Another example embodiment may include an apparatus provided at a home authentication server of a wireless network. The apparatus may include a network transceiver and a controller. The controller may be configured to determine a session key for a tunneled password-based authentication method provided between the home authentication server and a peer wireless node, the session key being determined based on a secret and one or more security parameters used for peer authentication of the authentication method between the home authentication server and the wireless peer node.

According to another example embodiment, a method may include determining a session key for an EAP-MSCHAPv2 (Extensible Authentication Protocol-Microsoft PPP CHAP Extension, version 2) method with a peer node, the determining being based on a secret and one or more security parameters used for EAP-MSCHAPv2 peer authentication.

According to another example embodiment, a method may include performing an EAP-MSCHAP (Extensible Authentication Protocol-Microsoft PPP CHAP Extension) protocol family method authentication based on one or more security parameters; and determining a master session key (MSK) and an extended master session key (EMSK) for a tunneled EAP-MSCHAP protocol family method between a peer node and an EAP server, the determining being based on a secret and one or more of the security parameters used for EAP-MSCHAP protocol family method authentication.

According to yet another example embodiment, a method may include performing an EAP-MSCHAPv2 (Extensible Authentication Protocol-Microsoft PPP CHAP Extension, version 2) peer authentication based on one or more security parameters, and determining an extended master session key (EMSK) for a tunneled EAP-MSCHAPv2 method with a peer node, the determining being based on a secret and one or more of the security parameters used for EAP-MSCHAPv2 peer authentication.

According to another example embodiment, an apparatus may include a network transceiver, and a controller. The controller may be configured to determine a session key for a tunneled EAP-MSCHAPv2 (Extensible Authentication Protocol-Microsoft PPP CHAP Extension, version 2) method with a peer node, the determining being based on a secret and one or more security parameters used for EAP-MSCHAPv2 peer authentication.

According to yet another example embodiment, an apparatus may include a network transceiver, and a controller. The controller may be configured to perform an EAP-MSCHAPv2 (Extensible Authentication Protocol-Microsoft PPP CHAP Extension, version 2) peer authentication based on one or more security parameters, and determine an extended master session key (EMSK) for a tunneled EAP-MSCHAPv2 method with a peer node, the determining being based on a secret and one or more of the security parameters used for EAP-MSCHAPv2 peer authentication.

The details of one or more implementations are set forth in the accompanying drawings and the description below. Other features will be apparent from the description and drawings.

### BRIEF DESCRIPTION OF THE DRAWINGS

FIG. 1 is a diagram illustrating a network according to an example embodiment.

FIG. 2 is a flow chart illustrating operation of a node according to an example embodiment.

FIG. 3 is a flow chart illustrating operation of a node according to another example embodiment.

FIG. 4 is a flow chart illustrating operation of a node according to yet another example embodiment.

FIG. 5 is a block diagram illustrating an apparatus that may be provided in a network node or other device according to an example embodiment.

### DETAILED DESCRIPTION

According to an example embodiment, MSCHAPv2 may be used as an EAP method (EAP-MSCHAPv2). However, MSCHAPv2 does not typically provide session keys MSK (Master Session Key) and EMSK (Extended Master Session Key), as required by RFC 3748. In another example embodiment, EAP-MSCHAPv2 may be used as an inner EAP method in a tunneled mechanism (such as EAP-TTLSv0 tunnel), where the outer TLS-based tunnel may provide for derivation of the MSK and EMSK keys. However, a problem may arise where a first EAP server may terminate the tunneled mechanism with the peer node, and a second EAP server (or authentication server) may terminate the EAP-MSCHAPv2 method with the peer node. In such case (of a split EAP server arrangement), the second EAP server terminating only the EAP-MSCHAPv2 method with the peer node may typically be unable to determine or derive MSK and EMSK session keys.

For example, in a wireless network, when the mobile station or peer device has roamed from its home EAP server (or home authentication server) to a visited EAP server (or visited or serving authentication server), the TLS tunnel (EAP tunneling mechanism) may be provided between the peer device and the visited EAP server. Also, the EAP-MSCHAPv2 inner method may run between the peer device and the home EAP server via the visited EAP server. Thus, in such case, the MSK and EMSK keys may be typically generated at the mobile station or peer and at the visited EAP server (where the tunnel terminates), but are typically not generated or derived at the home EAP server. Unfortunately, many applications are often provided by the home network where the home EAP server is located, and especially EMSK may be required or used there instead of being generated by the visited EAP server. Transfer of the EMSK key from the visited EAP server to the home EAP server is typically not possible, as EAP does not allow the EAP server to export or transfer EMSK keys.

The various techniques described herein may be applicable to, for example, one or more password-based authentication methods or protocols, such as MSCHAPv2. Similarly, the various techniques described herein may be applicable to the MSCHAP protocol family, which may include MSCHAPv2 and other versions or future generations of MSCHAP, and evolutions of MSCHAP. Thus, while MSCHAPv2 may be used herein in various examples for illustrative purposes, the various techniques are applicable to other protocols, and to other versions or evolutions of the MSCHAP protocol (MSCHAP protocol family). For example, an EAP method that uses a protocol from the MSCHAP protocol family (such as MSCHAPv2, or other versions or evolutions) may be referred to as an EAP-MSCHAP protocol family method. Therefore, EAP-MSCHAPv2 is an illustrative example of an EAP-MSCHAP protocol family method, but is not limited thereto.

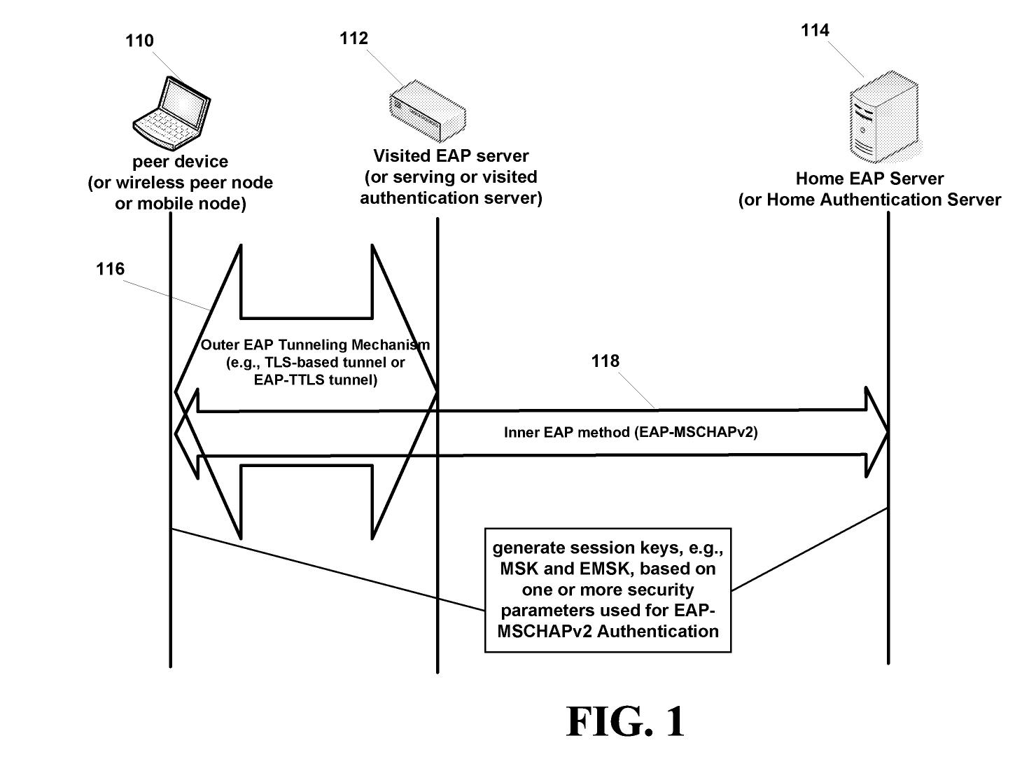

FIG. 1 is a diagram illustrating a network according to an example embodiment. According to an example embodiment, a wireless network(s) may support roaming of peer devices or peer nodes (wireless peer nodes). Each wireless peer node may have, for example, a home EAP server (or home authentication server), where basic registration and/or authorization for the peer node may occur, for example. When a wireless peer node roams to a different network or different domain, a serving or visited EAP server may serve the peer node.

Referring to FIG. 1, a peer device (or wireless peer node) 110 may have roamed from its home EAP server (or home authentication server) 114, and may now be served by a visited EAP server (or serving or visited authentication server) 112. A tunneling mechanism or tunnel 116, such as a TLS-based tunnel or a TTLS tunnel, may be provided between the wireless peer node 110 and visited EAP server 112. Within the tunnel, an inner EAP method (EAP-MSCHAPv2 method) may be provided between the wireless peer node 110 and the home EAP server 114, for example. As part of the tunneling, the visited EAP server 112 may encapsulate EAP-MSCHAPv2 packets received from home EAP server 114 for forwarding to peer node 110, and may decapsulate EAP-MSCHAPv2 packets received from peer node 110 for forwarding to home EAP server 114, as an example.

According to an example embodiment, the home EAP server 114 may determine or derive the MSK and/or EMSK keys for a password-based authentication method (e.g., EAP-MSCHAPv2 method or other EAP methods based on the MSCHAP protocol family, or the like) based on a secret (e.g., confidential password or secret key) and one or more security parameters used (e.g., previously used) for peer authentication of the authentication method/EAP method between the peer node and the home EAP server.

For example, a node or EAP server (e.g., home EAP server 114) may determine or derive MSK/EMSK keys for a EAP-MSCHAPv2 method with a peer node (e.g., for the EAP-MSCHAPv2 method between server 114 and peer node 110). The keys may be derived based on a secret (e.g., password or secret key) and one or more security parameters used by the EAP server 114 for EAP-MSCHAPv2 peer authentication with peer node 110. In this manner, home EAP server 114 may derive the session keys (MSK, EMSK) based on a secret key or password, and the known or reused security parameters (which may have also typically been used for peer authentication for the EAP method). This allows MSK/EMSK keys to be generated by reusing the security parameters used for EAP method peer authentication, for example.

Although not required, in an example embodiment, the EAP method (or password-based authentication method) may be a tunneled EAP method, such as a EAP-MSCHAPv2 method provided within a TLS-based tunnel, or a TTLS tunnel, as examples.

In an example embodiment, the MSK/EMSK keys may be determined or derived as a pseudo random function (PRF) or keyed hash function of a password (e.g., MSCHAPv2 password), one or more security parameters used for peer authentication of the EAP method, and possibly other information (such as a clear text string), for example. In an example embodiment, the pseudo-random function (PRF) may be, the TLS PRF (pseudo-random function) specified in IETF RFC2284, although this is merely an example and the disclosure is not limited thereto.

According to an example embodiment, the MSK/EMSK keys may be derived, according to the following, for example (where PRF indicates pseudo-random function, and “EAP-MSCHAPv2 keying material” is an example clear text string that may be added, but not required). For example, MSK may be derived based on the first 64 bits of the input string, while EMSK may be based on bits 64-127, although this is merely an example.
MSK=PRF(MSCHAPv2 password, “EAP-MSCHAPv2 keying material”, inputString) [0 . . . 63]
EMSK=PRF(MSCHAPv2 password, “EAP-MSCHAPv2 keying material”, inputString) [64 . . . 127]

The input String may be (or may include) one or more of the security parameters from the method authentication (e.g., mutual authentication between peer node and home EAP server). The security parameters (or input string) may, for example, be concatenated together, and may include (as examples):

Input string (e.g., one or more security parameters)=a peer identifier∥a Peer-Challenge (or challenge from the peer node)∥Name (Peer) (or name of the peer)∥Challenge (from the server)∥Name (of the server), or other security parameters. These are merely a few examples of security parameters and others may be used.

These (or one or more of these) security parameters may be communicated between the peer node and the EAP server as part of peer authentication. In the case of EAP-MSCHAPv2 method (or EAP method for MSCHAP protocol family), this peer authentication may include performing a peer authentication using a challenge-response exchange of messages between the peer node and EAP server, and this exchange of messages as part of this authentication or challenge-response process, may include one or more security parameters. In an example embodiment, one or more of these security parameters, since they are known by the peer node 110 and home EAP server, may be re-used as part of the MSK/EMSK key generation at the home EAP server 114 and peer node 110, for example.

In an example embodiment, the EAP-MSCHAPv2 password may be known in advance by both peer node 110 and home EAP server 114, or preconfigured.

In an alternative embodiment, a Change Password message in MSCHAPv2 protocol may be used to change or communicate an updated password to be used for deriving MSK/EMSK keys. For example, peer node 110 may generate an appropriate password string, e.g., based on a random string or based on user input. The peer node 110 may send this password string to the home EAP server 114 via a Change Password message of MSCHAPv2. The home EAP server 114 may extract the password string (password) and generate the MSK and EMSK keys based on this new password and the one or more security parameters used for peer authentication, as described above.

In another example embodiment, MSK and EMSK keys may be generated using the key generation function using the GKDF or generalized key distribution function, described in “EAP Generalized Pre-Shared Key (EAP-GPSK), draft-ietf-emu-eap-gpsk-05,” April, 2007.

The input string may include a number of security parameters, such as, for example: inputString=identifier∥Peer-Challenge∥Name (Peer)∥Challenge∥Name (Server)
MK=GKDF-32 (0x00, PL∥PSK∥inputString)
MSK=GKDF-160 (MK, inputString)[0 . . . 63]
EMSK=GKDF-160 (MK, inputString)[64 . . . 127]

Where PSK may be the MSCHAPv2 password (used for MSK/EMSK key generation).

The EAP Generalized Pre-Shared Key draft, describes a number of terms, as follows (this case is provided merely as an example, and the disclosure is not limited thereto).
EMSK: Extended Master Session Key is exported by the EAP method (64 octets)
MK: Master Key between the peer and EAP server from which all other EAP method session keys are derived (KS octets)
MSK: Master Session Key exported by the EAP method (64 octets)
PK: Session key generated from the MK and used during protocol exchange to encrypt protected data (KS octets)
PSK: Long-term key shared between the peer and the server (PL octets). This may be the MSCHAPv2 password.
SK: Session key generated from the MK and used during protocol exchange to demonstrate knowledge of the PSK (KS octets)

The length of the generated keys is 64 octets each, but can be longer than this based on the needs of the services. This is merely another example embodiment, and other implementations may be used.

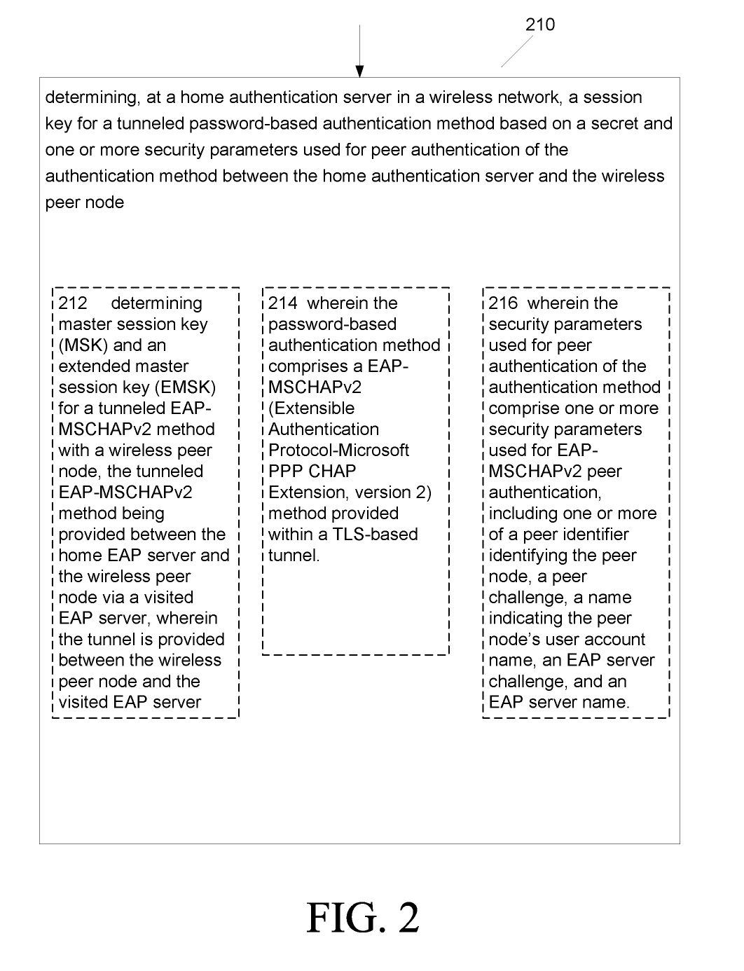

FIG. 2 is a flow chart illustrating operation of a node according to an example embodiment. At 210, a server (e.g., home authentication server or home EAP server 114, as examples) may determine a session key, e.g., MSK and/or EMSK for a tunneled password-based authentication method based on a secret (e.g., secret key or password) and one or more security parameters used for peer authentication of the authentication method between the home authentication server and the wireless peer node.

Determining operation 210 may include, for example, determining a master session key (MSK) and an extended master session key (EMSK) for a tunneled EAP-MSCHAPv2 method with a wireless peer node (212). The tunneled (e.g., via TTLS or other tunnel) EAP-MSCHAPv2 method may be provided between a home EAP server and the wireless peer node via a visited EAP server, and wherein the tunnel may be provided between the wireless peer node and the visited EAP server.

Also, in an example embodiment of the determining operation (210) of FIG. 2, the password-based authentication method may include an EAP-MSCHAPv2 method provided within a TLS-based tunnel (214).

In another example embodiment, the security parameters used for peer authentication of the authentication method may include one or more security parameters used for EAP-MSCHAPv2 peer authentication (216). These parameters may include, for example, one or more of a per identifier identifying the peer node, a peer challenge, a name indicating the peer node's user account name, an EAP server challenge, and/or an EAP server name (e.g., name of home EAP server). Other security parameters may be used, and in various combinations, for key derivation.

Similarly, an apparatus may be provided (e.g., a node in a network or server, a home EAP server or other device) may include a network transceiver (e.g., wired and/or wireless transceiver), and a controller. The controller may be configured to determine a session key for a tunneled password-based authentication method provided between the home authentication server and a peer wireless node, the session key being determined based on a secret and one or more security parameters used for peer authentication of the authentication method between the home authentication server and the wireless peer node.

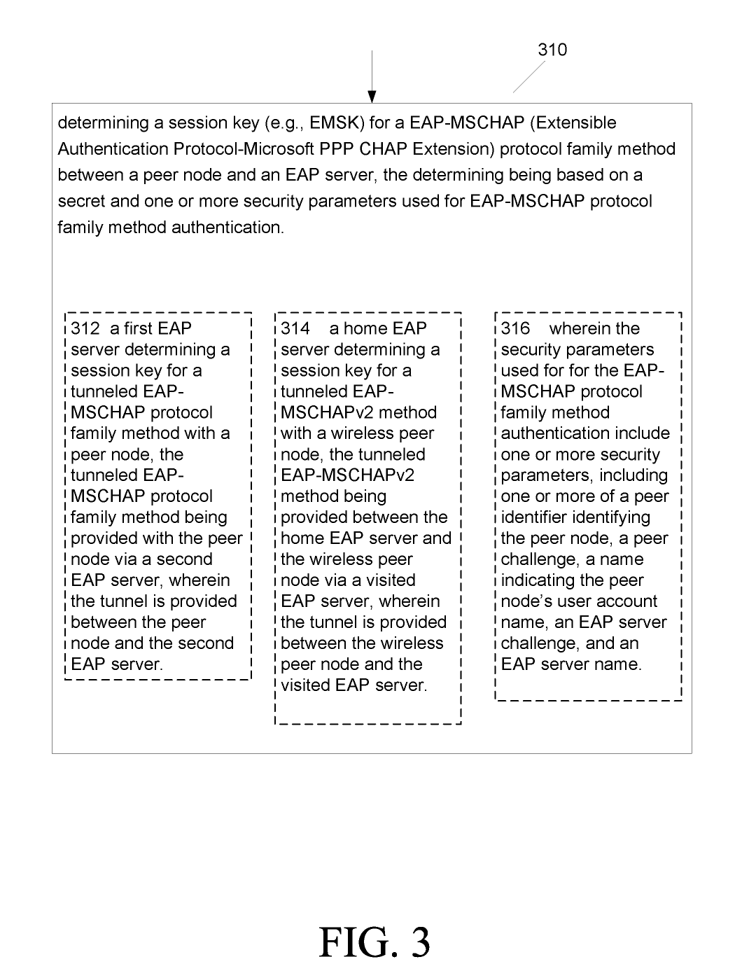

FIG. 3 is a flow chart illustrating operation of a node according to another example embodiment. At 310, a session key, such as an EMSK key, may be determined for a EAP-MSCHAP protocol family method between a peer node and an EAP server, the determining being based on a secret and one or more security parameters used for EAP-MSCHAP protocol family method authentication. For example, the EMSK may be determined (e.g., by the peer node or the EAP server) as a pseudo-random function or keyed hash function of a password and one or more of the security parameters used for the method peer authentication. It may be advantageous to determine or derive the EMSK/MSK keys at a home EAP server and/or the peer node using (or reusing) these security parameters, since these security parameters may be typically already known by the peer node and the home EAP server, e.g., the security parameters having already been used by the home EAP server for peer authentication of the EAP method.

In another example embodiment, at 312 in FIG. 3, the determining operation (310) may, for example, include a first EAP server determining a session key for a tunneled EAP-MSCHAP protocol family method with a peer node, the tunneled EAP-MSCHAP protocol family method being provided with the peer node via a second EAP server, wherein the tunnel is provided between the peer node and the second EAP server.

In another example embodiment, at 314 in FIG. 3, the determining operation (310) may include a home EAP server determining a session key for a tunneled EAP-MSCHAPv2 method with a wireless peer node, the tunneled EAP-MSCHAPv2 method being provided between the home EAP server and the wireless peer node via a visited EAP server, wherein the tunnel is provided between the wireless peer node and the visited EAP server.

In yet another example embodiment, at 316 in FIG. 3, in the determining operation (310), the security parameters used for the EAP-MSCHAP protocol family method authentication may include one or more security parameters, including one or more of a peer identifier identifying the peer node, a peer challenge, a name indicating the peer node's user account name, an EAP server challenge, and an EAP server name.

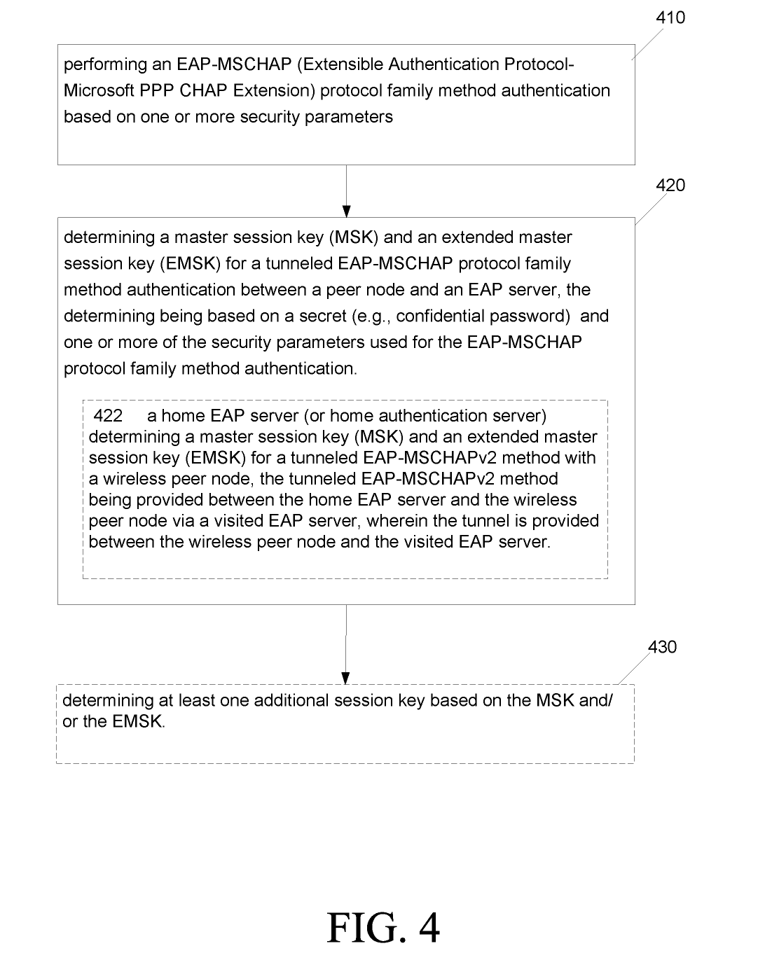

FIG. 4 is a flow chart illustrating operation of a node according to yet another example embodiment. At 410, an EAP-MSCHAP (Extensible Authentication Protocol-Microsoft PPP CHAP Extension) protocol family method authentication is performed based on one or more security parameters.

At 420, a master session key (MSK) and an extended master session key (EMSK) is determined for a tunneled EAP-MSCHAP protocol family method with a peer node, the determining being based on a secret (e.g., confidential password or other secret) and one or more of the security parameters used for the EAP-MSCHAP protocol family method authentication.

In another example embodiment, at 422, the determining operation (420) may include a home EAP server determining an extended master session key (EMSK) for a tunneled EAP-MSCHAPv2 method with a wireless peer node, the tunneled EAP-MSCHAPv2 method being provided between the home EAP server and the wireless peer node via a visited EAP server, wherein the tunnel is provided between the wireless peer node and the visited EAP server.

As shown in FIG. 4, another operation 430 may also be provided or performed. At 430, at least one additional session key may be determined or derived based on the MSK and/or EMSK, for example. These other keys may be provided to other nodes, e.g., for data transmission.

The example methods or operations illustrated in FIGS. 2-4 may be implemented by any node, such as a wireless node, network node, authentication server, EAP server, home EAP server, or other node.

According to another example embodiment, an apparatus may include a network transceiver, and a controller. The controller may be configured to determine a session key for a tunneled EAP-MSCHAPv2 (Extensible Authentication Protocol-Microsoft PPP CHAP Extension, version 2) method with a peer node, the determining being based on a secret and one or more security parameters used for EAP-MSCHAPv2 peer authentication.

According to yet another example embodiment, an apparatus may include a network transceiver, and a controller. The controller may be configured to perform an EAP-MSCHAPv2 (Extensible Authentication Protocol-Microsoft PPP CHAP Extension, version 2) peer authentication based on one or more security parameters, and determine an extended master session key (EMSK) for a tunneled EAP-MSCHAPv2 method with a peer node, the determining being based on a secret and one or more of the security parameters used for EAP-MSCHAPv2 peer authentication.

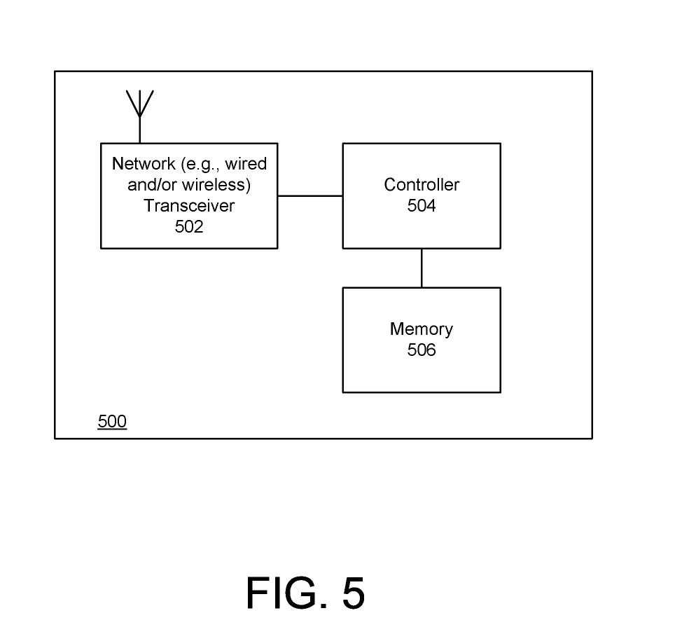

FIG. 5 is a block diagram illustrating an apparatus 500 that may be provided in a network node according to an example embodiment. The network node (e.g. server, base station, network apparatus, wireless node, mobile station or other node) may include, for example, a network transceiver 502 to transmit and receive signals via a network medium, such as a wired medium (e.g., Ethernet or other standard or protocol) or a wireless medium (e.g., via WLAN, WiMAX, cellular or other wireless protocol or standard). Apparatus 500 may also include a controller 504 to control operation of the node and execute instructions or software, and a memory 506 to store data and/or instructions.

Controller 504 may be programmable and capable of executing software or other instructions stored in memory or on other computer media to perform the various tasks and functions described above, such as one or more of the tasks, techniques or methods described herein.

In addition, a storage medium may be provided that includes stored instructions, when executed by a controller or processor that may result in the controller 604, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art.

What is claimed is:

1. A method comprising:
determining, at a home authentication server in a wireless network, a session key for a tunneled password-based authentication method based on a secret and one or more security parameters used for peer authentication of the authentication method between the home authentication server and the wireless peer node.

2. The method of claim 1 wherein the determining the session key comprises determining a master session key (MSK) and an extended master session key (EMSK) for a tunneled EAP-MSCHAPv2 method with a wireless peer node, the tunneled EAP-MSCHAPv2 method being provided between the home EAP server and the wireless peer node via a visited EAP server, wherein the tunnel is provided between the wireless peer node and the visited EAP server.

3. The method of claim 1 wherein the tunneled password-based authentication method comprises a MSCHAP (Microsoft PPP CHAP Extension) protocol family method within a tunnel.

4. The method of claim 1 wherein the tunneled password-based authentication method comprises an EAP-MSCHAP (Extensible Authentication Protocol-Microsoft PPP CHAP Extension) protocol family method within a tunnel.

5. The method of claim 1 wherein the tunneled password-based authentication method comprises a MSCHAP (Extensible Authentication Protocol-Microsoft PPP CHAP Extension) protocol family method provided within a TLS-based tunnel.

6. The method of claim 1 wherein the tunneled password-based authentication method comprises an EAP-MSCHAPv2 (Extensible Authentication Protocol-Microsoft PPP CHAP Extension, version 2) method provided within a TLS-based tunnel.

7. The method of claim 1 wherein the security parameters used for peer authentication of the authentication method comprise one or more security parameters used for EAP-MSCHAPv2 peer authentication, including one or more of a peer identifier identifying the peer node, a peer challenge, a name indicating the peer node's user account name, an EAP server challenge, and an EAP server name.

8. An apparatus provided in a wireless network comprising:
a network transceiver; and
a controller, the controller configured to:
determine a master session key (MSK) and an extended master session key (EMSK) for a tunneled password-based authentication method provided between a home authentication server and a wireless peer node, the MSK and EMSK being determined based on a secret and one or more security parameters used for authentication of the authentication method between the home authentication server and the wireless peer node.

9. The apparatus of claim 8 wherein the apparatus comprises the home authentication server.

10. The apparatus of claim 8 wherein the apparatus comprises the wireless peer node.

11. A method comprising:
determining a session key for a EAP-MSCHAP (Extensible Authentication Protocol-Microsoft PPP CHAP Extension) protocol family method between a peer node and an EAP server, the determining being based on a secret and one or more security parameters used for EAP-MSCHAP protocol family method authentication.

12. The method of claim 11 wherein the determining is performed based on a confidential EAP-MSCHAPv2 password or secret key and one or more security parameters used for EAP-MSCHAPv2 method authentication.

13. The method of claim 11 wherein the determining comprises a first EAP server determining a session key for a tunneled EAP-MSCHAP protocol family method with a peer node, the tunneled EAP-MSCHAP protocol family method being provided with the peer node via a second EAP server, wherein the tunnel is provided between the peer node and the second EAP server.

14. The method of claim 11 wherein the determining comprises a home EAP server determining a session key for a tunneled EAP-MSCHAPv2 method with a wireless peer node, the tunneled EAP-MSCHAPv2 method being provided between the home EAP server and the wireless peer node via a visited EAP server, wherein the tunnel is provided between the wireless peer node and the visited EAP server.

15. The method of claim 11 wherein the EAP-MSCHAP protocol family method comprises a tunneled EAP-MSCHAPv2 method running or provided within a TLS (Transport Layer Security)-based tunnel.

16. The method of claim 11 wherein the EAP-MSCHAPv2 method comprises a tunneled EAP-MSCHAPv2 method running or provided within a TTLS (Tunneled Transport Layer Security) tunnel.

17. The method of claim 11 wherein the security parameters used for EAP-MSCHAP protocol family method authentication include one or more security parameters, including one or more of a peer identifier identifying the peer node, a peer challenge, a name indicating the peer node's user account name, an EAP server challenge, and an EAP server name.

18. The method of claim 11 wherein the determining a session key comprises determining a master session key (MSK) or an extended master session key (EMSK) required by EAP (Extensible Authentication Protocol).

19. A method comprising:
performing an EAP-MSCHAP (Extensible Authentication Protocol-Microsoft PPP CHAP Extension) protocol family method authentication based on one or more security parameters; and
determining a master session key (MSK) and an extended master session key (EMSK) for a tunneled EAP-MSCHAP protocol family method between a peer node and an EAP server, the determining being based on a secret and one or more of the security parameters used for EAP-MSCHAP protocol family method authentication.

20. The method of claim 19 wherein the performing and the determining are performed by the peer node.

21. The method of claim 19 wherein the performing and the determining are performed by the EAP server.

22. A method comprising:
performing an EAP-MSCHAPv2 (Extensible Authentication Protocol-Microsoft PPP CHAP Extension, version 2) peer authentication based on one or more security parameters; and
determining a master session key (MSK) and an extended master session key (EMSK) for a tunneled EAP-MSCHAPv2 method with a peer node, the determining being based on a secret and one or more of the security parameters used for EAP-MSCHAPv2 peer authentication.

23. The method of claim 22 and further comprising determining at least one additional session key based on the EMSK.

24. The method of claim 22 wherein the determining is performed based on a confidential EAP-MSCHAPv2 password or secret key and one or more security parameters used for EAP-MSCHAPv2 peer authentication.

25. The method of claim 22 wherein the determining comprises determining a first EAP server determining a master session key (MSK) and an extended master session key (EMSK) for a tunneled EAP-MSCHAPv2 method with a peer node, the tunneled EAP-MSCHAPv2 method being provided with the peer node via a second EAP server, wherein the tunnel is provided between the peer node and the second EAP server.

26. The method of claim 22 wherein the determining comprises a home EAP server determining a master session key (MSK) and an extended master session key (EMSK) for a tunneled EAP-MSCHAPv2 method with a wireless peer node, the tunneled EAP-MSCHAPv2 method being provided between the home EAP server and the wireless peer node via a visited EAP server, wherein the tunnel is provided between the wireless peer node and the visited EAP server.

27. The method of claim 22 wherein the tunneled EAP-MSCHAPv2 method comprises a EAP-MSCHAPv2 method running or provided within a TLS (Transport Layer Security)-based tunnel.

28. The method of claim 22 wherein the tunneled EAP-MSCHAPv2 method comprises a EAP-MSCHAPv2 method running or provided within a TTLS (Tunneled Transport Layer Security) tunnel.

29. The method of claim 22 wherein the security parameters used for EAP-MSCHAPv2 peer authentication include a concatenation of one or more security parameters, including one or more of a peer identifier identifying the peer node, a peer challenge, a name indicating the peer node's user account name, an EAP server challenge, and an EAP server name.

30. An apparatus comprising:
a network transceiver; and
a controller, the controller configured to:
determine a session key for a tunneled EAP-MSCHAP (Extensible Authentication Protocol-Microsoft PPP CHAP Extension) protocol family method with a peer node, the determining being based on a secret and one or more security parameters used for the EAP-MSCHAP protocol family method peer authentication.

31. The apparatus of claim 30, wherein the apparatus comprises an EAP server operating as a home EAP server for a wireless peer node, and wherein the controller is configured to determine a master session key (MSK) and an extended master session key (EMSK) for a tunneled EAP-MSCHAPv2 method with the wireless peer node, the tunneled EAP-MSCHAPv2 method being provided with the wireless peer node via a visited EAP server, wherein the tunnel is provided between the wireless peer node and the visited EAP server.

32. An apparatus comprising:
a network transceiver; and
a controller, the controller configured to:
perform an EAP-MSCHAPv2 (Extensible Authentication Protocol-Microsoft PPP CHAP Extension, version 2) peer authentication based on one or more security parameters; and
determine a master session key (MSK) and an extended master session key (EMSK) for a tunneled EAP-MSCHAPv2 method with a peer node, the determining being based on a secret and one or more of the security parameters used for EAP-MSCHAPv2 peer authentication.
